(19) United States
(12) Patent Application Publication
(10) Pub. No.: US 2023/0419080 A1
(43) Pub. Date: Dec. 28, 2023

(54) METHOD FOR TRAINING ARTIFICIAL NEURAL NETWORK TO PREDICT FUTURE TRAJECTORIES OF VARIOUS TYPES OF MOVING OBJECTS FOR AUTONOMOUS DRIVING

(71) Applicant: Electronics and Telecommunications Research Institute, Daejeon (KR)

(72) Inventors: Dooseop CHOI, Daejeon (KR); Kyoung-Wook MIN, Daejeon (KR); Dong-Jin LEE, Daejeon (KR); Yongwoo JO, Daejeon (KR); Seung Jun HAN, Daejeon (KR)

(73) Assignee: Electronics and Telecommunications Research Institute, Daejeon (KR)

(21) Appl. No.: 18/301,037

(22) Filed: Apr. 14, 2023

(30) Foreign Application Priority Data
Jun. 28, 2022 (KR) 10-2022-0078986

(51) Int. Cl. G06N 3/0455; G06N 3/0442; G06N 3/08; B60W 60/00

(52) U.S. Cl. CPC G06N 3/0455; G06N 3/0442; G06N 3/08; B60W 60/0027; B60W 2554/4041; B60W 2556/10; B60W 2554/402; B60W 2420/42; B60W 2552/53; B60W 2556/40

(57) ABSTRACT

The present disclosure relates to an apparatus and a method for predicting future trajectories of various types of objects using an artificial neural network trained by a method for training an artificial neural network to predict future trajectories of various types of moving objects for autonomous driving. The apparatus for predicting future trajectories includes a shared information generation module configured to: collect location information of one or more objects around an autonomous vehicle for a predetermined time, generate past movement trajectories for the one or more objects based on the location information, and generate a driving environment feature map for the autonomous vehicle based on road information around the autonomous vehicle and the past movement trajectories; and a future trajectory prediction module configured to generate future trajectories for the one or more objects based on the past movement trajectories and the driving environment feature map.

### CROSS-REFERENCE TO RELATED APPLICATION

This application claims priority to and the benefit of Korean Patent Application No. 10-2022-0078986, filed on Jun. 28, 2022, the disclosure of which is incorporated herein by reference in its entirety.

### BACKGROUND

### 1. Technical Field

The present disclosure relates to a method for training an artificial neural network to predict future trajectories of various types of moving objects around an autonomous vehicle. More specifically, the present disclosure relates to a method for proposing a structure of an artificial neural network to predict plural future trajectories for each object from a past location record and a high-definition map of various types of moving objects and effectively training the corresponding artificial neural network.

### 2. Related Art

A general autonomous driving system (ADS) implements autonomous driving of a vehicle through processes of recognition, judgment, and control.

In the recognition process, the autonomous driving system finds static or dynamic objects around a vehicle and tracks their locations by utilizing data obtained from sensors, such as a camera, Lidar, and the like. Further, the autonomous driving system predicts the location and the posture of the autonomous vehicle (autonomous car) by recognizing lanes and surrounding buildings and comparing them with a high-definition map (HD map).

In the judgment process, the autonomous driving system generates a plurality of routes that suit the driving intention from the result of the recognition, and determines one route by judging risks of the respective routes.

Last, in the control process, the autonomous driving system controls the steering angle and the speed of the vehicle so that the vehicle moves along the route generated in the judgment process.

In the process in which the autonomous driving system judges the risk for each route in the judgment process, future movement prediction of surrounding moving objects is essential. For example, during a lane change, the autonomous driving system should judge in advance whether there is a vehicle in the lane intended to move and whether the corresponding vehicle will collide with the autonomous vehicle in the future, and for this, it is very important to predict future movements of the corresponding vehicle.

With the development of a deep neural network (DNN), many future trajectory prediction technologies of moving objects using the DNN have been proposed. For more accurate future trajectory prediction, the DNN is designed to satisfy the following conditions (refer to FIGS. 1A-1C).

(1) Utilization of a HD map or a driving environment image during future trajectory prediction (refer to FIG. 1A)

(2) Consideration of an interaction between moving objects during future trajectory prediction (refer to FIG. 1B)

(3) Resolution of movement ambiguity of moving objects through prediction of a plurality of future trajectories for each object (refer to FIG. 1C)

Condition (1) is to reflect a situation in that vehicles mainly move along the lanes, and people move along roads such as sidewalks, and condition (2) is to reflect a fact that movement of an object is affected by movement of a surrounding object. Last, condition (3) is to reflect the point that the future location of the object follows multi-mode distribution due to ambiguity of movement intention of the object.

Meanwhile, there are various kinds of objects (vehicle, pedestrian, and cyclist) around the autonomous vehicle, and the autonomous driving system should predict future trajectories of the objects regardless of the kinds of objects. However, the existing DNNs have been proposed in consideration of only a specific kind of object, and thus when being utilized in the autonomous driving system, the DNNs should be separately used according to the kinds of the objects. However, such a DNN operation method is very inefficient since resource sharing between different DNNs is not possible.

### SUMMARY

An object of the present disclosure is to propose a deep neural network (DNN) structure for future trajectory prediction of various types of objects and to present a method for effectively training the deep neural network.

The objects of the present disclosure are not limited to the above-described object, and other unmentioned objects may be clearly understood by those skilled in the art from the following description.

According to an embodiment of the present disclosure to achieve the above object, an apparatus for predicting future trajectories of various types of objects includes: a shared information generation module configured to: collect location information of one or more objects around an autonomous vehicle for a predetermined time, generate past movement trajectories for the one or more objects based on the location information, and generate a driving environment feature map for the autonomous vehicle based on road information around the autonomous vehicle and the past movement trajectories; and a future trajectory prediction module configured to generate future trajectories for the one or more objects based on the past movement trajectories and the driving environment feature map.

In an embodiment of the present disclosure, the shared information generation module may be configured to collect type information of the one or more objects, and the apparatus for predicting future trajectories of various types of objects may include a plurality of future trajectory prediction modules corresponding to respective types that the type information can have.

In an embodiment of the present disclosure, the shared information generation module may include: a location data receiver for each object configured to: collect location information of the one or more objects, and generate past movement trajectories for the one or more objects based on the location information; a driving environment context information generator configured to generate a driving environment context information image based on road information around the autonomous vehicle and the past movement trajectories; and a driving environment feature map generator configured to generate the driving environment feature map by inputting the driving environment context information image to a first convolutional neural network.

In an embodiment of the present disclosure, the future trajectory prediction module may include: an object past trajectory information extractor configured to generate a motion feature vector by using a long short-term memory (LSTM) based on the past movement trajectories; an object-centered context information extractor configured to generate an object environment feature vector by using a second convolutional neural network based on the driving environment feature map; and a future trajectory generator configured to generate the future trajectories by using a variational auto-encoder (VAE) and an MLP based on the motion feature vector and the object environment feature vector.

In an embodiment of the present disclosure, the driving environment context information generator may be configured to: extract the road information including a lane centerline from an HD map, and generate the driving environment context information image in a method for displaying the road information and the past movement trajectories on a 2D image.

In an embodiment of the present disclosure, the driving environment context information generator may be configured to: extract the road information including a lane centerline from an HD map, generate a road image based on the road information, generate a past movement trajectory image based on the past movement trajectories, and generate the driving environment context information image by combining the road image and the past movement trajectory image with each other in a channel direction.

In an embodiment of the present disclosure, the object-centered context information extractor may be configured to: generate a lattice template in which a plurality of location points are arranged in a lattice shape, move all the location points included in the lattice template to a coordinate system being centered around a location and a heading direction of a specific object, generate an agent feature map by extracting a feature vector at a location in the driving environment feature map corresponding to all the moved location points, and generate the object environment feature vector by inputting the agent feature map to a second convolutional neural network.

In an embodiment of the present disclosure, the object-centered context information extractor may be configured to set at least one of a horizontal spacing and a vertical spacing between the location points included in the lattice template based on the type of the specific object.

Further, according to an embodiment of the present disclosure, a method for training an artificial neural network to predict future trajectories of various types of objects includes: a training data generation step of generating past movement trajectories for one or more objects based on location information for a predetermined time about the one or more objects existing in a predetermined distance range around an autonomous vehicle based on a specific time point, generating a driving environment context information image for the autonomous vehicle through a method of displaying road information around the autonomous vehicle and the past movement trajectories on a 2D image, and generating answer future trajectories for the one or more objects based on the location information for the predetermined time about the one or more objects after the specific time point; a step of generating object future trajectories by inputting the past movement trajectories, the driving environment context information image, and the answer future trajectories to a deep neural network (DNN), and calculating a loss function value based on a difference between the object future trajectories and the answer future trajectories; and a step of training the DNN so that the loss function value becomes smaller.

In an embodiment of the present disclosure, the training data generation step may increase the driving environment context information image through at least one of a reversal, a rotation, and a color change, or a combination thereof.

In an embodiment of the present disclosure, the loss function may be an evidence lower bound (ELBO) loss.

Further, according to an embodiment of the present disclosure, a method for predicting future trajectories of various types of objects includes: a step of collecting location information of one or more objects around an autonomous vehicle for a predetermined time, and generating past movement trajectories for the one or more objects based on the location information; a step of generating a driving environment context information image based on road information around the autonomous vehicle and the past movement trajectories; a step of generating a driving environment feature map by inputting the driving environment context information image to a first convolutional neural network; a step of generating a motion feature vector by using a long short-term memory (LSTM) based on the past movement trajectories; a step of generating an object environment feature vector by using a second convolutional neural network based on the driving environment feature map; and a step of generating future trajectories for the one or more objects by using a variational auto-encoder (VAE) and an MLP based on the motion feature vector and the object environment feature vector.

The method may further include a step of transforming the past movement trajectories into an object-centered coordinate system. In this case, the step of generating the motion feature vector may generate the motion feature vector by using the LSTM based on the past movement trajectories having been transformed into the object-centered coordinate system.

In an embodiment of the present disclosure, the step of generating the driving environment context information image may extract the road information including a lane centerline from an HD map, and generate the driving environment context information image in a method for displaying the road information and the past movement trajectories on a 2D image.

In an embodiment of the present disclosure, the step of generating the driving environment context information image may extract the road information including a lane centerline from an HD map, generate a road image based on the road information, generate a past movement trajectory image based on the past movement trajectories, and generate the driving environment context information image by combining the road image and the past movement trajectory image with each other in a channel direction.

In an embodiment of the present disclosure, the step of generating the object environment feature vector may generate a lattice template in which a plurality of location points are arranged in a lattice shape, move all the location points included in the lattice template to a coordinate system being centered around a location and a heading direction of a specific object, generate an agent feature map by extracting a feature vector at a location in the driving environment feature map corresponding to all the moved location points, and generate the object environment feature vector by inputting the agent feature map to the second convolutional neural network.

In an embodiment of the present disclosure, the step of generating the object environment feature vector may set at least one of a horizontal spacing and a vertical spacing between the location points included in the lattice template based on the type of the specific object.

According to an embodiment of the present disclosure, it is possible to predict the future trajectories of various types of objects regardless of the types of the objects.

FIGS. 2A and 2B are exemplary diagrams illustrating the prediction results of future trajectories of a vehicle and a person in the same driving environment are predicted according to the present disclosure. The future trajectory prediction result of a vehicle is illustrated in FIG. 2A, and the future trajectory prediction result of a pedestrian is illustrated in FIG. 2B. In FIGS. 2A and 2B, a large circle and a small circle represent past trajectories of the vehicle and the pedestrian, respectively. Solid lines attached at the circles represent future trajectories of the respective objects. As can be seen from FIGS. 2A and 2B, the future trajectories of various types of objects may be well predicted according to the present disclosure.

Effects that can be obtained from the present disclosure are not limited to those described above, and other unmentioned effects will be able to be clearly understood by those of ordinary skill in the art to which the present disclosure pertains from the following description.

### BRIEF DESCRIPTION OF THE DRAWINGS

FIGS. 1A-1C are diagrams regarding design conditions of a deep artificial neural network to predict future trajectories of moving objects.

FIGS. 2A and 2B are exemplary diagrams illustrating the prediction results of future trajectories of a vehicle and a person in the same driving environment.

FIG. 3 is a block diagram illustrating the configuration of an apparatus for predicting future trajectories of various types of objects according to an embodiment of the present disclosure.

FIG. 4 is a block diagram illustrating the detailed configuration of the apparatus for predicting future trajectories of various types of objects according to the embodiment of the present disclosure.

FIG. 5A shows a 2D image about a lane centerline and crosswalks.

FIG. 5B shows a 2D image about past movement trajectories of objects.

FIGS. 6A-6C are diagrams explaining a process of extracting an agent feature map for a specific object from a driving environment feature map by using a lattice template.

FIGS. 7A-7C are exemplary diagrams of lattice templates and centerlines according to types of objects.

FIG. 8 is a diagram illustrating a DNN structure to generate future trajectories of objects according to the present disclosure.

FIGS. 9A and 9B are diagrams illustrating examples of generating new driving environment context information image by adding a certain angle to a driving environment context information image.

FIG. 10 is a flowchart explaining a method for training an artificial neural network to predict future trajectories of various types of objects according to an embodiment of the present disclosure.

FIG. 11 is a flowchart explaining a method for predicting future trajectories of various types of objects according to an embodiment of the present disclosure.

FIG. 12 is a block diagram illustrating a computer system for implementing the method according to the embodiment of the present invention.

### DETAILED DESCRIPTION

The advantages and features of the present disclosure and methods for achieving the advantages and features will be apparent by referring to embodiments to be described in detail with reference to the accompanying drawings. However, the present disclosure is not limited to the embodiments disclosed below, and it can be implemented in various different forms. However, the embodiments are provided to complete the present disclosure and to assist those of ordinary skill in the art in a comprehensive understanding of the scope of the present disclosure, and the present disclosure is only defined by the scope of the appended claims. Meanwhile, terms used in the description are to explain the embodiments, but are not intended to limit the present disclosure. In the description, unless specially described on the contrary, the constituent element(s) may be in a singular or plural form. The term “comprises” and/or “comprising” used in the description should be interpreted as not excluding the presence or addition of one or more other constituent elements, steps, operations, and/or elements in addition to the mentioned constituent elements, steps, operations, and/or elements. In the description, the “movement” includes “stop”. For example, even in case that an object stops, the “movement trajectory” of the object, which is a locational sequence of the object in accordance with the time flow, may be present.

In explaining the present disclosure, the detailed explanation of the related known technology will be omitted if it is determined that the explanation may vague the subject matter of the present disclosure unnecessarily.

Hereinafter, embodiments of the present disclosure will be described in detail with reference to the accompanying drawing. In describing the present disclosure, in order to facilitate the overall understanding, the same reference numerals are used for the same means regardless of the drawing numbers.

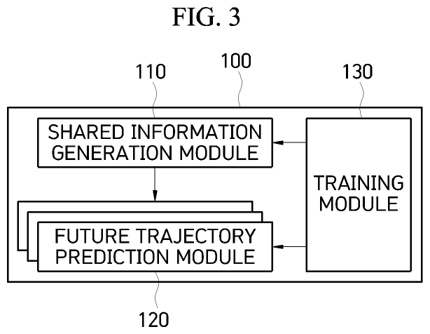

FIG. 3 is a block diagram illustrating the configuration of an apparatus for predicting future trajectories of various types of objects according to an embodiment of the present disclosure.

An apparatus 100 for predicting future trajectories of various types of objects according to the embodiment of the present disclosure is an apparatus for generating future trajectories of objects around an autonomous vehicle through prediction based on information about the objects, roads, and traffic situation, and may support an autonomous driving system or may be included in the autonomous driving system. The apparatus 100 for predicting future trajectories of various types of objects may include a shared information generation module 110 and a future trajectory prediction module 120, and may further include a training module 130. The future trajectory prediction module 120 may be composed of a plurality of modules in accordance with the types of the objects. For example, in case that M types of objects are present, M future trajectory prediction modules 120-1 to 120-M may be included in the apparatus 100 for predicting future trajectories of various types of objects as the future trajectory prediction module 120.

The shared information generation module 110 generates past movement trajectories of moving objects around the autonomous vehicle based on location and posture information (object information) of the objects, and generates a driving environment feature map (scene context feature map) for the autonomous vehicle based on the road/traffic information (e.g., lane information) around the autonomous vehicle and the past movement trajectories. The shared information generation module 110 may receive the location and posture information (e.g., heading angle) of the moving objects around the autonomous vehicle from an object detection and tracking module of the autonomous vehicle (3D object detection & tracking module), and may generate the past movement trajectories of the plurality of moving objects. For example, in case that the training module 130 trains the artificial neural network to predict the future trajectories included in the apparatus 100 for predicting future trajectories of various types of objects, the shared information generation module 110 may pre-acquire the location and posture information (e.g., 5 seconds) of the moving objects from the object detection and tracking module of the autonomous vehicle, generate past movement trajectories Xᵢ based on a part thereof (e.g., 2 seconds), and generate and transfer answer future trajectories Y to the future trajectory prediction module 120 based on the remaining part (e.g., 3 seconds) thereof.

Here, of course, the location and posture information of the moving objects or object movement trajectory data received from the object detection and tracking module of the autonomous vehicle may be manually corrected by a person, or may be corrected by a predetermined algorithm.

Further, the shared information generation module 110 may generate a driving environment context information image based on the road/traffic information within a range of a predetermined distance around the location of the autonomous vehicle and the past movement trajectories of the moving objects present within the predetermined distance. The “driving environment context information” is information about the roads and traffic situation and objects around the autonomous vehicle being driven, and may include the types of the moving objects around the autonomous vehicle and the movement trajectories together with the lanes, road signs, and traffic signals. The “driving environment context information image” means the “driving environment context information” expressed by a 2D image. The shared information generation module 110 generates a driving environment feature map by inputting the driving environment context information image to the artificial neural network. Accordingly, the “driving environment feature map” may be a feature map in the form in which the driving environment context information image is encoded.

The future trajectory prediction module 120 generates the future trajectories of the objects based on the past movement trajectories of the objects and the driving environment feature map. The future trajectory prediction module 120 generates a motion feature vector by encoding the past movement trajectories of the objects, and generates an object environment feature vector (moving object scene feature vector) based on the driving environment feature map. The “motion feature vector” is a vector in which the past movement trajectory information of the objects is encoded, and the “object environment feature vector” is a vector in which information about the road and traffic situations around the objects and the types and movement trajectories of other objects are encoded. Further, the future trajectory prediction module 120 generates the future trajectories of the objects based on the motion feature vector, the object environment feature vector, and a random noise vector.

The training module 130 trains the artificial neural network included in the shared information generation module 110 and the future trajectory prediction module 120. The training module 130 may proceed with the training by controlling the shared information generation module 110 and the future trajectory prediction module 120, and as needed, the training module 130 may increase training data.

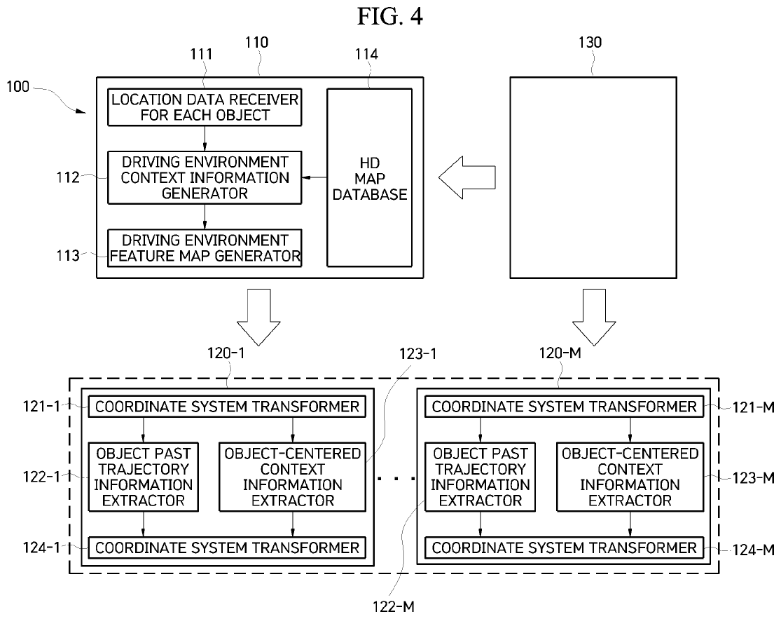

FIG. 4 is a block diagram illustrating the detailed configuration of the apparatus for predicting future trajectories of various types of objects according to the embodiment of the present disclosure.

The shared information generation module 110 generates the driving environment feature map (scene context feature map (F)) shared by the various types of objects around the autonomous vehicle. The future trajectories of the objects are predicted by extracting the object-centered driving environment feature map from the shared information F. The future trajectory prediction module 120-K is a future trajectory prediction module for object types Cₖ. If total M object types being processed by the autonomous driving system are present, total M future trajectory prediction modules exist.

The shared information generation module 110 includes a location data receiver 111 for each object, a driving environment context information generator 112, and a driving environment feature map generator 113, and may further include an HD map database 114. Hereinafter, functions of respective constituent elements of the shared information generation module 110 will be described in detail.

The location data receiver 111 for each object serves to receive in real time the types, locations, and posture information (hereinafter, object information) of the moving objects around the autonomous vehicle detected in a recognition process, and to store and manage the received information for each object. The movement trajectories for past T_{obs} seconds of moving objects Aᵢ that can be obtained at current time t are expressed as Xᵢ=[x_{t-H}_{_{obs}}, . . . , xₜ]. Here, xₜ=[x, y] is the locations of the objects Aᵢ at time t, and is generally expressed as a global coordinate system. Further, H_{obs}=T_{obs}*Sampling Rate (Hz). If total N objects are detected at current time t, [X₁, . . . , X_{N}] may be obtained. The location data receiver 111 for each object transfers the movement trajectory information of the objects to the driving environment context information generator 112 and the future trajectory prediction module 120. If the future trajectory prediction module 120 is composed of the plurality of modules 120-1 to 120-M in accordance with the types of the objects, the location data receiver 111 for each object transfers the object movement trajectory information to the future trajectory prediction module that matches the type of the object included in the object information. For example, if a specific future trajectory prediction module 120-K is a module corresponding to a “pedestrian” among the types of the objects, the location data receiver 111 for each object transfers the object movement trajectory information of which the type of the object is the “pedestrian” to the future trajectory prediction module 120-K.

The driving environment context information generator 112 generates a driving environment context information image I by drawing all lane information within a predetermined distance (e.g., R meters) around the location of the autonomous vehicle at current time t and the past movement trajectories [X₁, . . . , X_{N}] of the objects on a 2D image having a size of H*W.

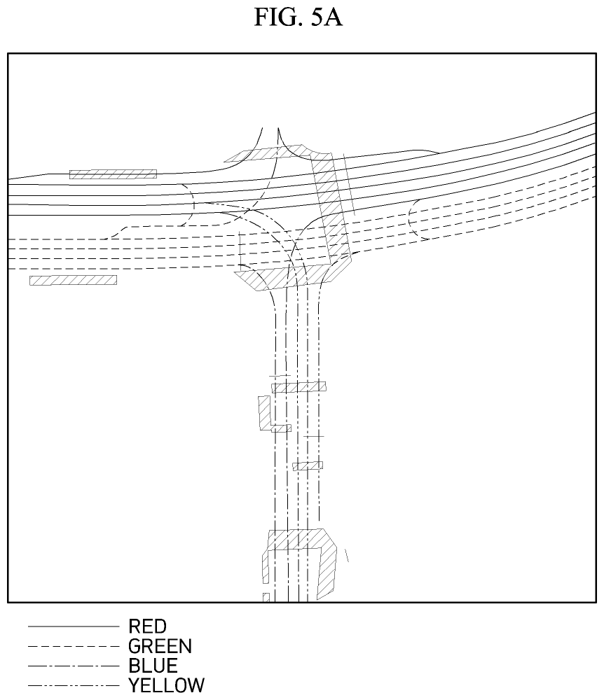

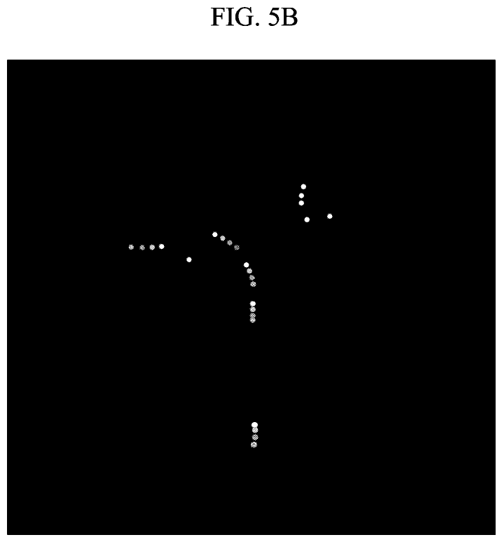

FIG. 5A shows a 2D image about a lane centerline and crosswalks. In order to obtain the above image, the driving environment context information generator 112 first obtains, from the HD map, all lane centerline segments within a predetermined distance around the location of the autonomous vehicle at time t. It is assumed that Lₘ=[l₁, . . . , l_{M}] is the m-th lane centerline segment. Here, lₖ=[x, y] is location point coordinates constituting the lane centerline segment. In order to draw Lₘ on the image, the driving environment context information generator 112 first transforms all location point coordinates in the segment into a coordinate system being centered around the location and heading of the autonomous vehicle at time t. Thereafter, the driving environment context information generator 112 draws a straight line connecting location coordinates in Lₘ on the image. In this case, the driving environment context information generator 112 differently colors the straight lines connecting the two consecutive location coordinates in accordance with the direction of the straight line. For example, the color of the straight line connecting lₖ₊₁ and lₖ is determined as follows.

1) After a vector connecting two coordinates vₖ₊₁=lₖ₊₁−lₖ=[vₓ, v_{y}] is calculated, the direction of the vector d=tan⁻¹(v_{y}, vₓ) is calculated.

2) The hue is determined as a value obtained by dividing the direction (degree) of the vector by 360, and after the saturation and the value are designated as 1, the (hue, saturation, value) value is transformed into the (R, G, B) value.

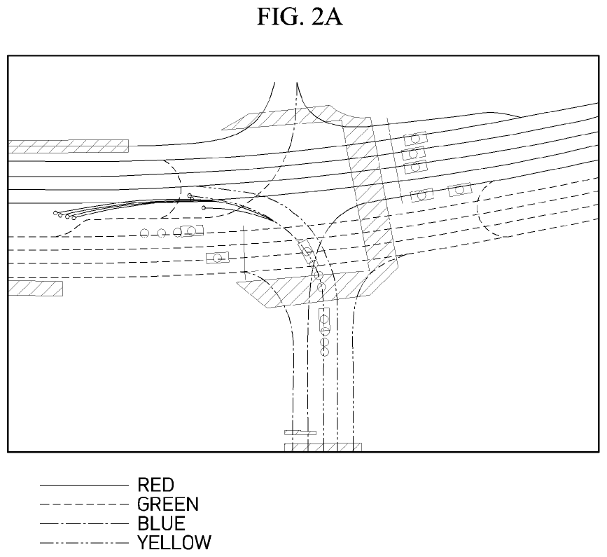

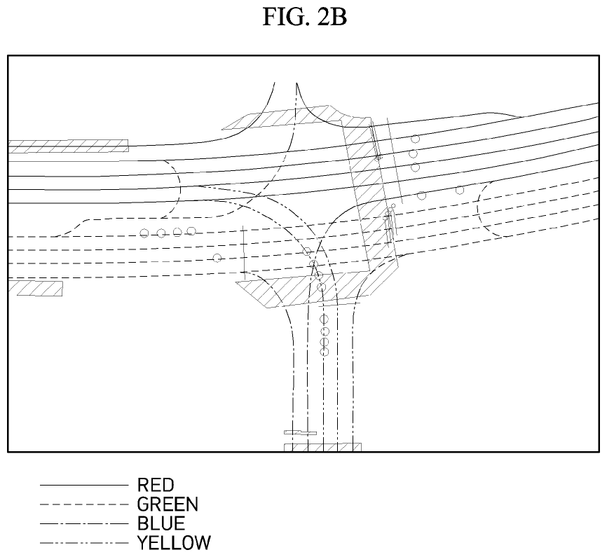

The driving environment context information generator 112 determines the transformed (R, G, B) value as the color of the straight line connecting lₖ₊₁ and lₖ, and draws the straight line on the image. In FIG. 5A, the solid line represents red line, the dashed line represents green line, the dash-dotted line represents blue line, and the dash-double dotted line represents yellow line (same as FIGS. 2A, 2B, 6B, 9A and 9B). Then, the driving environment context information generator 112 draws a crosswalk segment on the same image or on another image. For example, the driving environment context information generator 112 may draw the crosswalk segment on the lane centerline image, or may draw the crosswalk segment on a separate crosswalk image after generating the crosswalk image. The crosswalk is drawn with a gray value of a specific brightness. For reference, in case of drawing the crosswalk segment on the crosswalk image, the driving environment context information generator 112 configures an image set by combining the crosswalk images in a channel direction of the lane centerline image.

The driving environment context information generator 112 may draw other HD map constituent elements in addition to the lane centerline and the crosswalk, and as in the above-described method, may draw the constituent elements with different colors or a gray value of a specific brightness depending on the direction of the constituent elements. In case that the driving environment context information generator 112 draws the HD map constituent elements on a separate image other than the existing image, the driving environment context information generator 112 configures an image set by combining the separate image on which the HD map constituent elements are drawn in the channel direction of the lane centerline image. The driving environment context information generator 112 may utilize the HD map constituent elements through reception thereof from the outside or through extraction thereof from the HD map database 114. Of course, the HD map constituent elements include the lane centerline segment and the crosswalk segment.

Next, the driving environment context information generator 112 draws the past movement trajectories of the moving objects on the image. FIG. 5B exemplifies a 2D image for the past movement trajectories of the objects. The driving environment context information generator 112 passes through the following processes in order to draw the past movement trajectories Xᵢ of the moving objects Aᵢ on the image. First, the driving environment context information generator 112 transforms all location coordinates in Xᵢ into the coordinate system being centered around the location and heading of the autonomous vehicle at time t. Next, the driving environment context information generator 112 draws the respective locations in Xᵢ in the shape of a specific figure, such as a circle, on the image. In this case, the location at a time close to the current time t is drawn bright, and the location at a time far from the current time t is drawn dark. Further, depending on the types of the objects, the figures have different shapes or different sizes. The generated image is interconnected in the channel direction of the lane centerline image.

The size of the driving environment context information image I generated by the driving environment context information generator 112 may be represented as H*W*C. Here, C is equal to the number of channels of the image generated by the driving environment context information generator 112.

The driving environment feature map generator 113 generates a driving environment feature map (scene context feature map (F)) by inputting the driving environment context information image I to the convolutional neural network (CNN). The CNN that is used in the driving environment feature map generator 113 may include a layer specified to generate the driving environment feature map. Further, the existing widely used neural network, such as ResNet, may be used as it is as the CNN, and the CNN may be configured by partially correcting the existing neural network.

The future trajectory prediction module 120 includes a coordinate system transformer 121, an object past trajectory information extractor 122, an object-centered context information extractor 123, and a future trajectory generator 124.

In case of M types of objects being processed by the autonomous driving system, total M future trajectory prediction modules 120 having the same structure exist. If the number of types of the moving objects Aᵢ is Cₖ, the future trajectories of the moving objects Aᵢ are generated by the future trajectory prediction module 120-k. In case that the future trajectory prediction module 120 includes a plurality of future trajectory prediction modules 120-1 to 120-M, the future trajectory prediction module 120-1 is configured to include a coordinate system transformer 121-1, an object past trajectory information extractor 122-1, an object-centered context information extractor 123-1, and a future trajectory generator 124-1, and the future trajectory prediction module 120-M is configured to include a coordinate system transformer 121-M, an object past trajectory information extractor 122-M, an object-centered context information extractor 123-M, and a future trajectory generator 124-M. The respective future trajectory prediction modules have different types of objects being processed, but have the same basic function. Functions of respective constituent elements of the future trajectory prediction module 120 will be described in detail.

The coordinate system transformer 121 transforms the object past trajectory information received from the shared information generation module 110 into the object-centered coordinate system, and transfers the object movement trajectory information in accordance with the object-centered coordinate system to the object past trajectory information extractor 122 and the object-centered context information extractor 123. The coordinate system transformer 121 transforms all the past location information of the objects included in the past trajectories of the objects into the coordinate system being centered around the location and the heading of the moving objects at the current time t.

The object past trajectory information extractor 122 generates a motion feature vector mᵢ by encoding the past movement trajectories of the object Aᵢ by using a long short-term memory (LSTM). The object past trajectory information extractor 122 uses a hidden state vector output most recently from the LSTM as a motion feature vector mᵢ of the object Aᵢ. The hidden state vector may be a vector in which the past movement trajectory information of the object Aᵢ up to the present is reflected.

The object-centered context information extractor 123 extracts an agent feature map Fᵢ that is a feature map for a specific object in the driving environment feature map F. For this, the object-centered context information extractor 123 performs the following tasks.

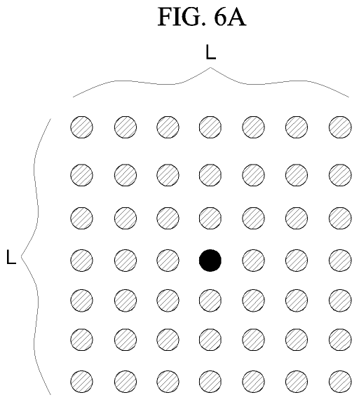

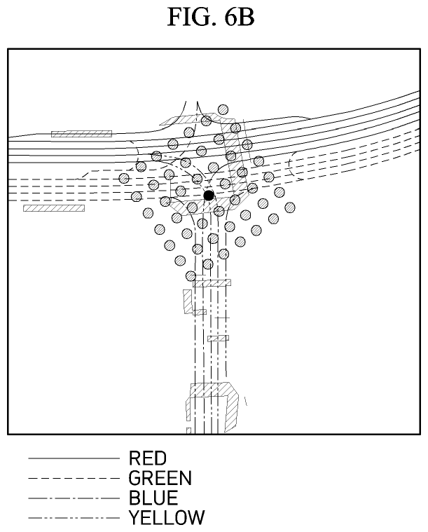

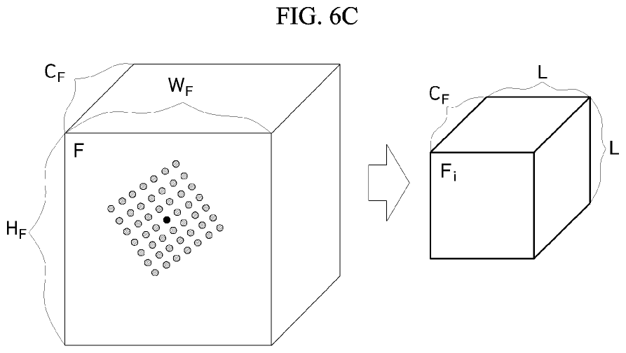

1) The object-centered context information extractor 123 generates lattice templates R=[r₀, . . . , r_{K}] that keep a predetermined distance by G meters in x- and y-axis directions around the location (0,0). Here, rₖ=[rₓ, r_{y}] means one location point in the lattice template. FIG. 6A shows an example of a lattice template. Here, black circle represents a center location point r₀=[0,0], and hatched circles are remaining location points that are spaced apart from one another at intervals of G meters.

2) All locations in the lattice template are moved to the coordinate system being centered on the location and the posture of the object Aᵢ at the present time t. FIG. 6B shows an example thereof.

3) The agent feature map Fᵢ for the corresponding object is generated by extracting the feature vector at a location in the driving environment feature map F corresponding to each location point in the transformed lattice template. FIG. 6C shows this process.

The object-centered context information extractor 123 generates the object environment feature vector (moving object scene feature vector) sᵢ that is the final output of the object-centered context information extractor 123 by inputting the agent feature map Fᵢ to the convolutional neural network (CNN).

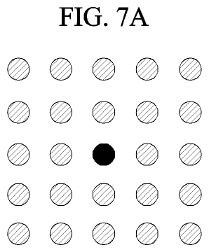

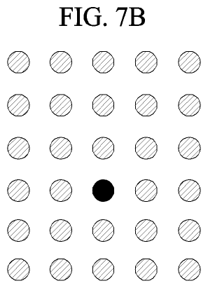

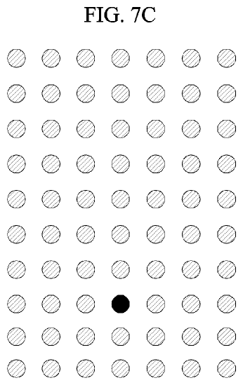

The object-centered context information extractor 123 may make distances between the location points in the lattice template different from one another depending on the types of the objects, and as a result, the horizontal/vertical lengths of the lattice template may be different from one another. For example, in case of the vehicle, since the front area is more important than the rear area, the vertical length may be set to be longer than the horizontal length, and the center location point may be located in a lower end area of the lattice template. FIGS. 7A-7C show examples thereof. FIG. 7A shows a lattice template in case of the pedestrian. FIG. 7B shows a lattice template in case of the motorcycle, and FIG. 7C shows a lattice template in case of the vehicle.

The future trajectory generator 124 generates the future trajectory information of the object Aᵢ based on the motion feature vector mᵢ, the object environment feature vector sᵢ, and the random noise vector z. The future trajectory generator 124 generates the future trajectory information Ŷ of the object Aᵢ by inputting the vector fᵢ obtained by combining the motion feature vector mᵢ, the object environment feature vector sᵢ, and the random noise vector z in a feature dimension direction to a multi-layer perceptron (MLP). The future trajectories Ŷ may be expressed as [yₜ₊₁, . . . , y_{t+H}_{_{pred}}]. Here, yₜ₊₁ is the location of the object at time (t+1), and the H_{pred} is H_{pred}=T_{pred}*Sampling Rate (Hz). The T_{pred} means a temporal range of the future trajectories. The future trajectory generator 124 may further generate the future trajectories of the objects Aᵢ by repeating the above-described process through additional generation of the random noise vector z.

The future trajectory generator 124 generates the random noise vector z by using a variational auto-encoder (VAE) technique. Specifically, the future trajectory generator 124 generates the random noise vector z by using the neural network NN defined as an encoder and a prior. The future trajectory generator 124 generates the random noise vector z based on a mean vector and a variance vector generated by the encoder during training, and generates the random noise vector z based on the mean vector and the variance vector generated by the prior during testing. The encoder and the prior may be composed of a multi-layer perceptron (MLP).

Under the assumption that the result of encoding the answer future trajectories to the LSTM network is mᵢ^{Y}, the encoder outputs the mean vector and the variance vector from the input in which the motion feature vector mᵢ, the object environment feature vector sᵢ, and the encoded answer future trajectories mᵢ^{Y} are put together. Further, the prior outputs the mean vector and the variance vector from the input in which the motion feature vector mᵢ and the object environment feature vector sᵢ are put together.

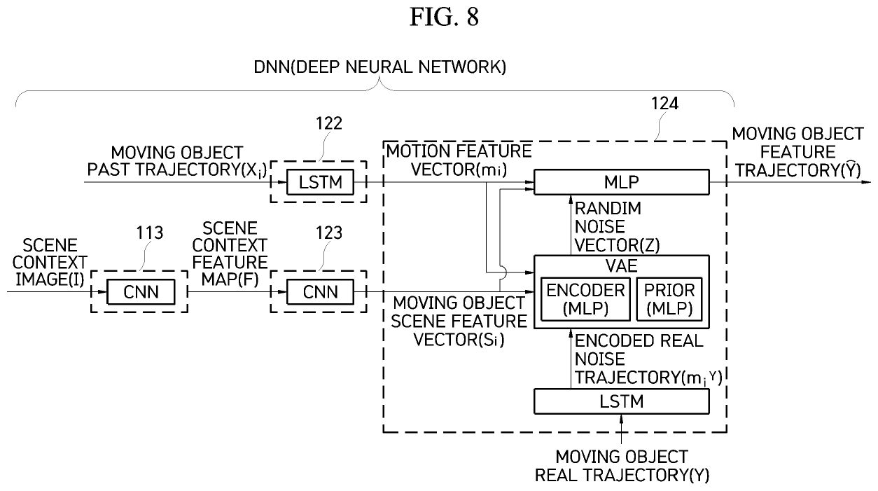

The training module 130 trains the artificial neural network included in the shared information generation module 110 and the future trajectory prediction module 120. As illustrated in FIG. 8, the shared information generation module 110 generates the driving environment feature map F by using the CNN based on the driving environment context information image I, and the future trajectory prediction module 120 generates the future trajectories Ŷ of the objects by using the LSTM, CNN, VAE (MLP), and MLP based on the object past movement trajectories transformed into the object-centered coordinate system and the driving environment feature map F. Here, the CNN of the driving environment feature map generator 113, the LSTM of the object past trajectory information extractor 122, the CNN of the object-centered context information extractor 123, and the LSTM, the VAE, and the MLP of the future trajectory generator 124 are connected to one another to form one deep neural network (DNN). The training module 130 trains the DNN for various types of objects through a method for adjusting a parameter (e.g., weight value) of each neural network existing in the DNN in a direction in which a defined loss function is minimized. As a loss function for the training module 130 to train the DNN, an evidence lower bound loss (ELBO loss) may be used. In this case, the training module 130 trains the DNN in a direction in which the ELBO loss is minimized. Mathematical expression 1 represents the ELBO loss.

L_{ELBO}=∥Y−Ŷ∥²βKL(Q∥P) [Mathematical expression 1]

In Mathematical expression 1, β is a certain constant, and KL(∥) represents KL divergence. Q and P denote Gaussian distribution defined as the outputs (mean vector and variance vector) of the encoder and the prior, respectively.

The training module 130 may increase training data in order to improve the training performance of the DNN. For example, the training module 130 may improve the training effect of the DNN by increasing the driving environment context information image I input to the CNN of the driving environment feature map generator 113 as follows. For this, the training module 130 may control the driving environment context information generator 112.

(1) Reverse left and right of the driving environment context information image I: The image I being used during training is reversed left and right. At the same time, the sign of the y-direction (direction rotated by 90 degrees from the proceeding direction of the autonomous vehicle) component values of the past movement location points of the objects is changed. As a result, the training data can be increased twice.

(2) Addition of a certain angle ΔD (degree) to the direction (degree) of a straight line connecting two consecutive location coordinates in the lane centerline segment during generation of the driving environment context information image I: As described above, a method for determining the color depending on the direction of the straight line connecting the two location coordinates is as follows.

1) The vector direction d=tan⁻¹(v_{y}, vₓ) is calculated after the vector vₖ₊₁=lₖ₊₁−lₖ=[vₓ, v_{y}] connecting the two coordinates is calculated.

2) The hue is determined as a value obtained by dividing the direction (degree) of the vector by 360, and after the saturation and the value are designated as 1, the (hue, saturation, value) value is transformed into the (R, G, B) value.

The hue is determined as a value obtained by dividing the direction (degree) of the vector by 360, and after the saturation and the value are designated as 1, the (hue, saturation, value) value is transformed into the (R, G, B) value.

In the above process 1), a value obtained by adding a certain angle ΔD to d and then dividing the added value by 360 may be determined as a new d′. In summary, this is expressed as in Mathematical expression 2.

d′=mod(d+ΔD,360) [Mathematical expression 2]

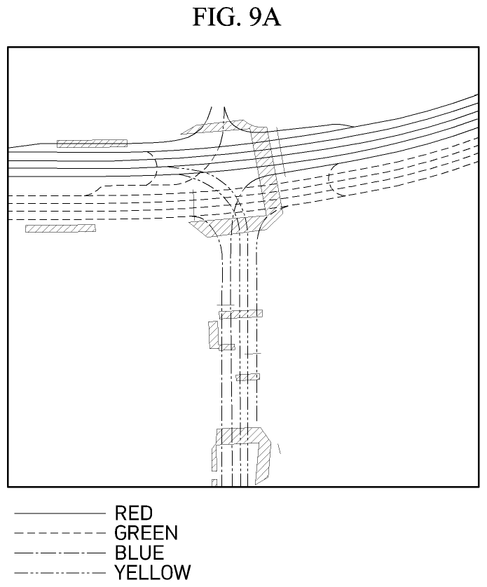

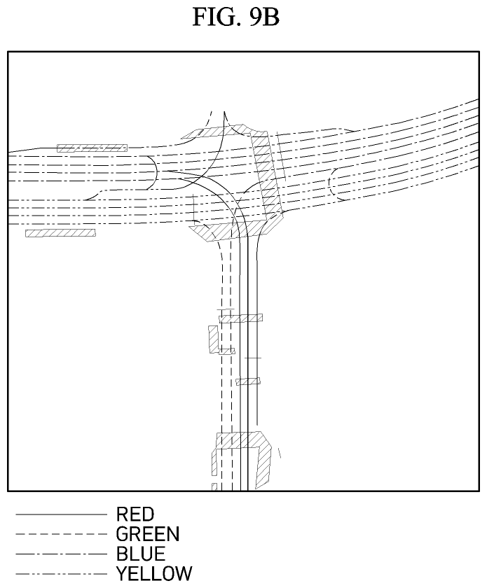

For reference, when the driving environment context information generator 112 generates one driving environment context information image I, the ΔD may be applied to all the lane centerline segments. When generating the next image I, the ΔD may be changed to a new random value by the training module 130. FIGS. 9A and 9B are diagrams illustrating examples of generating new driving environment context information image by adding a certain angle to a driving environment context information image. FIG. 9A represents the driving environment context information image I in case of ΔD=0, and FIG. 9B represents the driving environment context information image I in case of ΔD=90. Due to the difference between the hue values, it can be known that the color of the lane centerline has been changed.

The training module 130 may increase the training data through the above-described methods (1) and (2), and the DNN may be trained so as to recognize the lanes in different directions more easily. For example, by increasing the driving environment context information image I being used for training by adding a certain angle ΔD (degree) thereto, the DNN may generate the future trajectories between the color values rather than a specific color value itself.

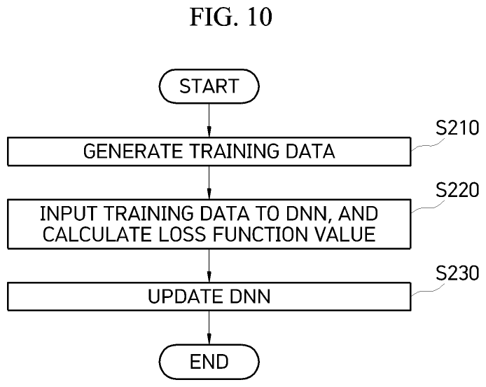

FIG. 10 is a flowchart explaining a method for training an artificial neural network to predict future trajectories of various types of objects according to an embodiment of the present disclosure.

A method for training an artificial neural network to predict future trajectories of various types of objects according to an embodiment of the present disclosure includes a step S210, a step S220, and a step S230.

As described above, the artificial neural network is a deep neural network (DNN) that receives an input of the past movement trajectories Xᵢ of the objects and the driving environment context information image I, and generates future trajectory information Ŷ of the objects Aᵢ. The DNN may be configured as in FIG. 8. During training, the artificial neural network further receives an input of the answer future trajectories Y of the objects Aᵢ.

The step S210 is a training data generation step. The apparatus 100 for predicting future trajectories of various types of objects generates the past movement trajectory information Xᵢ of the objects based on the types, locations, and posture information (object information) of the moving objects around the autonomous vehicle detected in the recognition process. The apparatus 100 for predicting future trajectories of various types of objects may generate the past movement trajectory information for each object by collecting the object information for a predetermined time range before a reference time t, and combining the location information of the objects included in the object information for each object in the temporal order. For the DNN input, the apparatus 100 for predicting future trajectories of various types of objects may transform the past movement trajectory information to follow an object-centered coordinate system. In this case, a plurality of objects may be present around the autonomous vehicle. Further, the apparatus 100 for predicting future trajectories of various types of objects generates the driving environment context information image I by drawing all lane information within a predetermined distance (e.g., R meters) around the location of the autonomous vehicle at a reference time t and the past movement trajectories [X₁, . . . , X_{N}] of the objects on a 2D image having a size of H*W. In the training process according to the present disclosure, the reference time t is a specific past time. The apparatus 100 for predicting future trajectories of various types of objects may increase the driving environment context information image I that is used for the training through the above-described method, such as the reverse left and right or the ΔD addition. Further, the apparatus 100 for predicting future trajectories of various types of objects may receive an input of the trajectories (answer future trajectories Y of the objects after the reference time t, and may utilize the trajectories as the training data. Further, the apparatus 100 for predicting future trajectories of various types of objects may generate the trajectories (answer future trajectories Y) of the objects by combining the location information for the predetermined time of the objects after the reference time t in accordance with the temporal order. The data for the DNN training, that is, the training data, may be configured to include the past movement trajectory information Xᵢ of the objects, the driving environment context information image I, and the answer future trajectories Y. The details of the step S210 may refer to the above-described contents with respect to the shared information generation module 110, the future trajectory prediction module 120, and the training module 130.

The step S220 is the step of generating the future trajectory information by inputting the training data to the DNN and calculating a loss function value. The apparatus 100 for predicting future trajectories of various types of objects generates the future trajectories Ŷ of the objects by inputting the training data (past movement trajectory information xᵢ of the objects, the driving environment context information image I, and the answer future trajectories Y) to the DNN, and calculates the loss function value based on the difference between the answer future trajectories Y and the future trajectories Ŷ of the objects. Here, the loss function may be an evidence lower bound loss (ELBO loss). An example of the ELBO loss may be as in Mathematical expression 1. The details of the step S220 may refer to the contents as described above with respect to the training module 130.

The step S230 is a DNN update step. The apparatus 100 for predicting future trajectories of various types of objects trains the DNN to predict the various types of the objects through a method for adjusting a parameter (e.g., weight value) of each neural network existing in the DNN in a direction in which a loss function value is minimized. The details of the step S230 may refer to the above-described contents with respect to the training module 130.

In the training method according to the present embodiment, the steps S210 to S230 may be repeated, or only the steps S220 and S230 may be repeated. Further, if the loss function value is within the predetermined range as the result of proceeding with the step S220, the training may be ended without proceeding with the step S230.

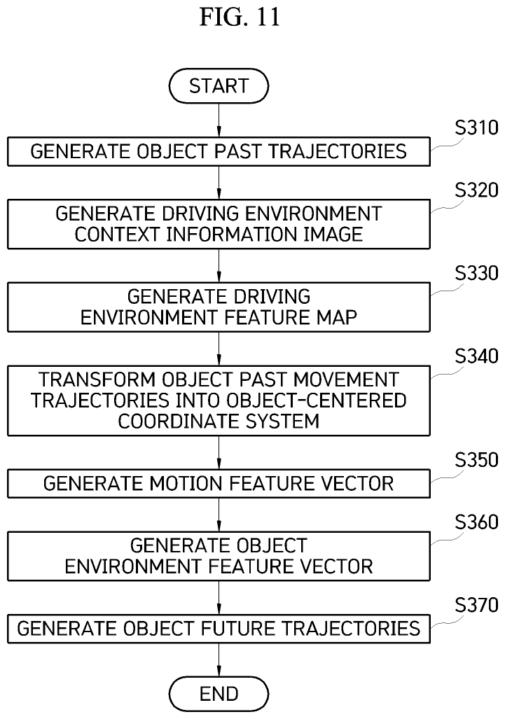

FIG. 11 is a flowchart explaining a method for predicting future trajectories of various types of objects according to an embodiment of the present disclosure.

The method for predicting future trajectories of various types of objects according to an embodiment of the present disclosure includes steps S310 to S370.

The step S310 is a step of generating past trajectories of the objects. The apparatus 100 for predicting future trajectories of various types of objects receives in real time the types, locations, and posture information (object information) of the moving objects around the autonomous vehicle detected in a recognition process, and stores and manages the received information for each object. The apparatus 100 for predicting future trajectories of various types of objects generates the past trajectories of the objects based on the location information of the objects. The movement trajectories for the past T_{obs} seconds of the moving objects Aᵢ that can be obtained at current time t are expressed as Xᵢ=[x_{t-H}_{_{obs}}, . . . , xₜ]. Here, xₜ=[x, y] is the locations of the objects Aᵢ at time t, and is generally expressed as a global coordinate system. Further, H_{obs}=T_{obs}*Sampling Rate (Hz). If the total N objects are detected at current time t, the apparatus 100 for predicting future trajectories of various types of objects may obtain the past movement trajectories [X₁, . . . , X_{N}] for the N objects.

The step S320 is a driving environment context information image generation step. The apparatus 100 for predicting future trajectories of various types of objects generates a driving environment context information image I by drawing all lane information within a predetermined distance (e.g., R meters) around the location of the autonomous vehicle at current time t and the past movement trajectories [X₁, . . . , X_{N}] of the objects on a 2D image having a size of H*W. The detailed contents for the step S320 refers to the driving environment context information generator 112.

The step S330 is a driving environment feature map generation step. The apparatus 100 for predicting future trajectories of various types of objects generates a driving environment feature map (scene context feature map F) by inputting the driving environment context information image I to a convolutional neural network (CNN). The CNN that is used in the step S330 may include a layer specified to generate the driving environment feature map. Further, the existing widely used neural network, such as ResNet, may be used as it is as the CNN, and the CNN may be configured by partially correcting the existing neural network.

The step S340 is a step of transforming the past movement trajectories of the objects into an object-centered coordinate system. The apparatus 100 for predicting future trajectories of various types of objects transforms the object past movement trajectories (object past trajectory information) into the object-centered coordinate system. Specifically, the apparatus 100 for predicting future trajectories of various types of objects transforms the entire object past location information included in the past trajectories of the objects into the coordinate system being centered on the locations and the heading of the moving objects at the current time t.

The step S350 is a step of generating a motion feature vector. As described above, the “motion feature vector” is a vector in which the past movement trajectory information of the objects is encoded. The apparatus 100 for predicting future trajectories of various types of objects generates the motion feature vector mᵢ by encoding the past movement trajectories of the object Aᵢ by using the long short-term memory (LSTM) network. The apparatus 100 for predicting future trajectories of various types of objects uses a hidden state vector output most recently from the LSTM as the motion feature vector mᵢ of the object Aᵢ.

The step S360 is a step of generating the object environment feature vector. As described above, the “object environment feature vector” is a vector in which information about the roads around the objects and traffic situations and types and movement trajectories of other objects is encoded. The apparatus 100 for predicting future trajectories of various types of objects extracts an agent feature map Fᵢ that is a feature map for a specific object in the driving environment feature map F. For this, the apparatus 100 for predicting future trajectories of various types of objects performs the following tasks.

1) The lattice templates R=[r₀, . . . , r_{K}] that keep a predetermined distance by G meters in x- and y-axis directions around the location (0,0) are generated. Here, rₖ=[rₓ, r_{y}] means one location point in the lattice template. FIG. 6A shows an example of the lattice template. Here, black circle represents the center location point r₀=[0,0], and hatched circles are remaining location points that are spaced apart from one another at intervals of G meters.

2) All locations in the lattice template are moved to the coordinate system being centered on the location and the posture of the object Ai at the present time t. FIG. 6B shows an example thereof.

3) The agent feature map Fᵢ for the corresponding object is generated by extracting the feature vector at the location in the driving environment feature map F corresponding to each location point in the transformed lattice template. FIG. 6C shows this process.

The apparatus 100 for predicting future trajectories of various types of objects generates the object environment feature vector (moving object scene feature vector) sᵢ by inputting the agent feature map Fᵢ to the convolutional neural network (CNN).

The apparatus 100 for predicting future trajectories of various types of objects may make distances between the location points in the lattice template different from one another depending on the types of the objects, and as a result, the horizontal/vertical lengths of the lattice template may be different from one another. For example, in case of the vehicle, since the front area is more important than the rear area, the vertical length may be set to be longer than the horizontal length, and the center location point may be located in the lower end area of the lattice template.

The step S370 is a step of generating the object future trajectories. The apparatus 100 for predicting future trajectories of various types of objects generates the future trajectory information of the object Aᵢ based on the motion feature vector mᵢ, the object environment feature vector sᵢ, and the random noise vector z. The apparatus 100 for predicting future trajectories of various types of objects generates the future trajectory information Ŷ of the object Aᵢ by inputting the vector fᵢ obtained by combining the motion feature vector mᵢ, the object environment feature vector sᵢ, and the random noise vector z in the feature dimension direction to the multi-layer perceptron (MLP). The future trajectories Ŷ may be expressed as [yₜ₊₁, . . . , y_{t+H}_{_{pred}}]. Here, yₜ₊₁ is the location of the object at time (t+1), and the H_{pred} is H_{pred}=T_{pred}*Sampling Sampling Rate (Hz). The T_{pred} means the temporal range of the future trajectories. The apparatus 100 for predicting future trajectories of various types of objects may further generate the future trajectories of the objects Aᵢ by repeating the above-described process through additional generation of the random noise vector z.

The apparatus 100 for predicting future trajectories of various types of objects generates the random noise vector z by using the variational auto-encoder (VAE) technique. Specifically, the apparatus 100 for predicting future trajectories of various types of objects generates the random noise vector z by using the neural network NN defined as the encoder and the prior. The apparatus 100 for predicting future trajectories of various types of objects generates the random noise vector z based on the mean vector and the variance vector generated by the encoder during training, and generates the random noise vector z based on the mean vector and the variance vector generated by the prior during testing. The encoder and the prior may be composed of the multi-layer perceptron (MLP).

Under the assumption that the result of encoding the answer future trajectories Y that is the information for training to the LSTM network is mᵢ^{Y}, the encoder outputs the mean vector and the variance vector from the input in which the motion feature vector mᵢ, the object environment feature vector sᵢ, and the encoded answer future trajectories mᵢ^{Y} are put together. Further, the prior outputs the mean vector and the variance vector from the input in which the motion feature vector mᵢ and the object environment feature vector sᵢ are put together.

As described above, the method for training an artificial neural network to predict future trajectories of various types of objects and the method for predicting future trajectories of various types of objects have been described with reference to the flowcharts presented in the drawings. For simple explanation, the above methods have been illustrated and explained as a series of blocks, but the present disclosure is not limited to the order of the blocks, and some blocks may happen in the different order from that of other blocks as illustrated and described in the description or simultaneously with the other blocks. In order to achieve the same or similar results, various different branches, flow routes, and block orders may be implemented. Further, all blocks illustrated to implement the methods described in the description may not be required.

As described above, the method for training an artificial neural network to predict future trajectories of various types of objects and the method for predicting future trajectories of various types of objects may interwork with each other. That is, after the DNN for predicting future trajectories of various types of objects according to the present disclosure is trained through the above training method, the above prediction method may be executed.

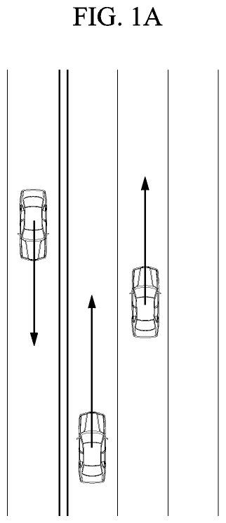

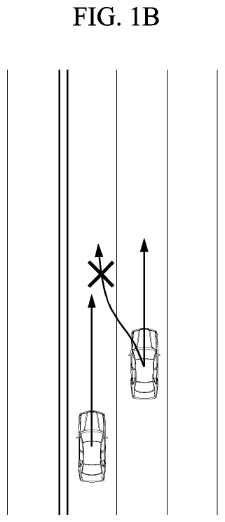

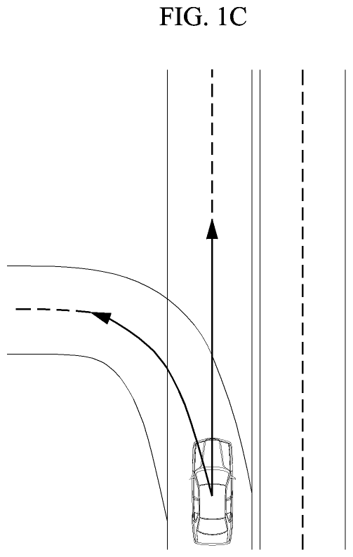

Meanwhile, in the above explanation made with reference to FIGS. 10 and 11, respective steps may be further divided into additional steps or may be combined into fewer steps in accordance with the implementation examples of the present disclosure. Further, if necessary, some steps may be omitted, or the order of the steps may be changed. In addition, even other omitted contents of FIGS. 1A to 9C may be applied to the contents of FIGS. 10 and 11. Further, even other omitted contents of FIGS. 10 and 11 may be applied to the contents of FIGS. 1A to 9C.

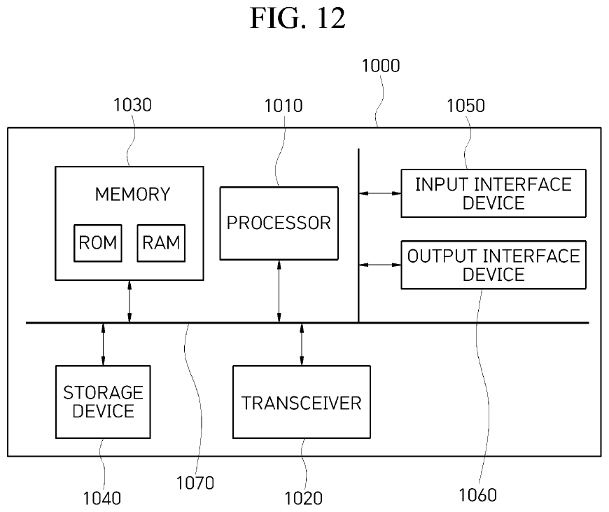

FIG. 12 is a block diagram illustrating a computer system for implementing the method according to the embodiment of the present invention.

Referring to FIG. 12, The computer system 1000 may include at least one processor 1010, a memory 1030 for storing at least one instruction to be executed by the processor 1010, and a transceiver 1020 performing communications through a network. The transceiver 1020 may transmit or receive a wired signal or a wireless signal.

The computer system 1000 may further include a storage device 1040, an input interface device 1050 and an output interface device 1060. The components of the computer system 1000 may be connected through a bus 1070 to communicate with each other.

The processor 1010 may execute program instructions stored in the memory 1030 and/or the storage device 1040. The processor 1010 may include a central processing unit (CPU) or a graphics processing unit (GPU), or may be implemented by another kind of dedicated processor suitable for performing the methods of the present disclosure.

The memory 1030 may load the program instructions stored in the storage device 1040 to provide to the processor 1010. The memory 1030 may include, for example, a volatile memory such as a read only memory (ROM) and a nonvolatile memory such as a random access memory (RAM).

The storage device 1040 may store the program instructions that can be loaded to the memory 1030 and executed by the processor 1010. The storage device 1040 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

For reference, constituent elements according to embodiments of the present disclosure may be implemented in the form of software or hardware, such as a digital signal processor (DSP), a field programmable gate array (FPGA), or an application specific integrated circuit (ASIC), and may perform specific roles.

However, the “constituent elements” do not mean limited to software or hardware, but the respective constituent elements may be configured to reside on an addressable storage medium, or may be configured to play one or more processors.

Accordingly, the constituent elements include, by way of example, constituent elements, such as software constituent elements, object-oriented software constituent elements, class constituent elements, and task constituent elements, processes, functions, attributes, procedures, subroutines, segments of program code, drivers, firmware, microcode, circuitry, data, databases, data structures, tables, arrays, and variables.

The constituent elements and the functionality provided in the constituent elements may be combined into fewer constituent elements or further separated into additional constituent elements.

In this case, it will be understood that each block of the flowchart illustrations, and combinations of blocks in the flowchart illustrations can be implemented by computer program instructions. These computer program instructions can be mounted on a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to implement functions in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable data processing apparatus to produce a process being executed by a computer such that the instructions that execute on the computer or other programmable data processing apparatus provide steps for implementing the functions specified in the flowchart block or blocks.

Also, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In this case, the term “unit” or “module”, as used in an embodiment, means, but is not limited to, a software or hardware constituent element, such as field programmable gate array (FPGA) or application specific integrated circuit (ASIC), and performs certain tasks. However, “unit” or “module” is not meant to be limited to software or hardware. The term “unit” or “module” may advantageously be configured to reside on the addressable storage medium and configured to execute on one or more processors. Thus, “unit” or “module” may include, by way of example, constituent elements, such as software constituent elements, object-oriented software constituent elements, class constituent elements and task constituent elements, processes, functions, attributes, procedures, subroutines, segments of program code, drivers, firmware, microcode, circuitry, data, databases, data structures, tables, arrays, and variables. The functionality provided in the constituent elements, “units”, or “modules” may be combined into fewer constituent elements, “nits”, or “modules”, or further separated into additional constituent elements, “units”, or “modules”. Further, the constituent elements, “units”, and “modules” may be implemented to operate one or more CPUs in a device or a security multimedia card.

Although the present disclosure has been described with reference to the preferred embodiments, it can be understood by those skilled in the art to which the present disclosure pertains that the present disclosure can be variously changed and modified within a range that does not deviate from the idea and region of the present disclosure described in the appended claims.

What is claimed is:

1. An apparatus for predicting future trajectories of various types of objects comprising:
a shared information generation module configured to: collect location information of one or more objects around an autonomous vehicle for a predetermined time, generate past movement trajectories for the one or more objects based on the location information, and generate a driving environment feature map for the autonomous vehicle based on road information around the autonomous vehicle and the past movement trajectories; and
a future trajectory prediction module configured to generate future trajectories for the one or more objects based on the past movement trajectories and the driving environment feature map.

2. The apparatus of claim 1, wherein the shared information generation module is configured to collect type information of the one or more objects, and
wherein the apparatus for predicting future trajectories of various types of objects comprises a plurality of future trajectory prediction modules corresponding to respective types that the type information can have.

3. The apparatus of claim 1, wherein the shared information generation module comprises:
a location data receiver for each object configured to: collect location information of the one or more objects, and generate past movement trajectories for the one or more objects based on the location information;
a driving environment context information generator configured to generate a driving environment context information image based on road information around the autonomous vehicle and the past movement trajectories; and
a driving environment feature map generator configured to generate the driving environment feature map by inputting the driving environment context information image to a first convolutional neural network.

4. The apparatus of claim 1, wherein the future trajectory prediction module comprises:
an object past trajectory information extractor configured to generate a motion feature vector by using a long short-term memory (LSTM) based on the past movement trajectories;
an object-centered context information extractor configured to generate an object environment feature vector by using a second convolutional neural network based on the driving environment feature map; and
a future trajectory generator configured to generate the future trajectories by using a variational auto-encoder (VAE) and an MLP based on the motion feature vector and the object environment feature vector.

5. The apparatus of claim 3, wherein the driving environment context information generator is configured to: extract the road information including a lane centerline from an HD map, and generate the driving environment context information image in a method for displaying the road information and the past movement trajectories on a 2D image.

6. The apparatus of claim 3, wherein the driving environment context information generator is configured to: extract the road information including a lane centerline from an HD map, generate a road image based on the road information, generate a past movement trajectory image based on the past movement trajectories, and generate the driving environment context information image by combining the road image and the past movement trajectory image with each other in a channel direction.

7. The apparatus of claim 4, wherein the object-centered context information extractor is configured to: generate a lattice template in which a plurality of location points are arranged in a lattice shape, move all the location points included in the lattice template to a coordinate system being centered around a location and a heading direction of a specific object, generate an agent feature map by extracting a feature vector at a location in the driving environment feature map corresponding to all the moved location points, and generate the object environment feature vector by inputting the agent feature map to a second convolutional neural network.

8. The apparatus of claim 7, wherein the object-centered context information extractor is configured to set at least one of a horizontal spacing and a vertical spacing between the location points included in the lattice template based on the type of the specific object.

9. A method for training an artificial neural network to predict future trajectories of various types of objects, the method comprising:
a training data generation step of generating past movement trajectories for one or more objects based on location information for a predetermined time about the one or more objects existing in a predetermined distance range around an autonomous vehicle based on a specific time point, generating a driving environment context information image for the autonomous vehicle through a method of displaying road information around the autonomous vehicle and the past movement trajectories on a 2D image, and generating answer future trajectories for the one or more objects based on the location information for the predetermined time about the one or more objects after the specific time point;
a step of generating object future trajectories by inputting the past movement trajectories, the driving environment context information image, and the answer future trajectories to a deep neural network (DNN), and calculating a loss function value based on a difference between the object future trajectories and the answer future trajectories; and
a step of training the DNN so that the loss function value becomes smaller.

10. The method of claim 9, wherein the training data generation step increases the driving environment context information image through at least one of a reversal, a rotation, and a color change, or a combination thereof.

11. The method of claim 9, wherein the loss function is an evidence lower bound (ELBO) loss.

12. A method for predicting future trajectories of various types of objects, the method comprising:
a step of collecting location information of one or more objects around an autonomous vehicle for a predetermined time, and generating past movement trajectories for the one or more objects based on the location information;
a step of generating a driving environment context information image based on road information around the autonomous vehicle and the past movement trajectories;
a step of generating a driving environment feature map by inputting the driving environment context information image to a first convolutional neural network;
a step of generating a motion feature vector by using a long short-term memory (LSTM) based on the past movement trajectories;
a step of generating an object environment feature vector by using a second convolutional neural network based on the driving environment feature map; and
a step of generating future trajectories for the one or more objects by using a variational auto-encoder (VAE) and an MLP based on the motion feature vector and the object environment feature vector.

13. The method of claim 12, further comprising a step of transforming the past movement trajectories into an object-centered coordinate system,
wherein the step of generating the motion feature vector generates the motion feature vector by using the LSTM based on the past movement trajectories having been transformed into the object-centered coordinate system.

14. The method of claim 12, wherein the step of generating the driving environment context information image extracts the road information including a lane centerline from an HD map, and generates the driving environment context information image in a method for displaying the road information and the past movement trajectories on a 2D image.

15. The method of claim 12, wherein the step of generating the driving environment context information image extracts the road information including a lane centerline from an HD map, generates a road image based on the road information, generates a past movement trajectory image based on the past movement trajectories, and generates the driving environment context information image by combining the road image and the past movement trajectory image with each other in a channel direction.

16. The method of claim 12, wherein the step of generating the object environment feature vector generates a lattice template in which a plurality of location points are arranged in a lattice shape, moves all the location points included in the lattice template to a coordinate system being centered around a location and a heading direction of a specific object, generates an agent feature map by extracting a feature vector at a location in the driving environment feature map corresponding to all the moved location points, and generates the object environment feature vector by inputting the agent feature map to the second convolutional neural network.

17. The method of claim 16, wherein the step of generating the object environment feature vector sets at least one of a horizontal spacing and a vertical spacing between the location points included in the lattice template based on the type of the specific object.
